(19) United States
(12) Patent Application Publication
(10) Pub. No.: US 2004/0249962 A1
(43) Pub. Date: Dec. 9, 2004

(54) Method and system for accessing video and multimedia electronic mail

(75) Inventor: Daniel Lecomte, Paris (FR)

Correspondence Address: IP DEPARTMENT OF PIPER RUDNICK LLP, ONE LIBERTY PLACE, SUITE 4900, 1650 MARKET ST, PHILADELPHIA, PA, 19103, US

(73) Assignee: Medialive, a corporation of France, Paris (FR)

(21) Appl. No.: 10/854,399

(22) Filed: May 26, 2004

Related U.S. Application Data
(63) Continuation of application No. PCT/FR02/04096, filed on Nov. 28, 2002.

(30) Foreign Application Priority Data
Nov. 28, 2001 (FR) 01/15388

(51) Int. Cl. G06F 15/16

(52) U.S. Cl. 709/229; 709/206

(57) ABSTRACT

A method for accessing video electronic mail and/or video programs, and/or video sequences received by and/or stored in multimedia servers by a wide area network by authorized users equipped with devices in a distribution system for accessing video and multimedia electronic mail from a single-line telephone or a mobile or cellular voice telephone for display under selected conditions on television screens, including accessing an applicable multimedia server via the wide area telecommunication network with a telephone; verifying the identity and authorization of the user by the server; preloading a transfer protocol and/or a decoding or unscrambling software program from the server to a video interface device connected to the wide area telecommunication network; ordering transfer of one or more video or multimedia electronic mails, video or multimedia data or program(s) or sequence(s) to the video interface device for substantially immediate display or for at least a partial storage and/or delayed display; verifying the identity of the user and of rights of the user in relation to possible restrictions of use; and displaying, transferring, recording or processing the video electronic mail(s) and/or program(s) and/or sequence(s) transferred on the instructions of the user.

### RELATED APPLICATION

This is a continuation of International Application No. PCT/FR02/04096, with an international filing date of Nov. 28, 2002 (WO 03/047202, published Jun. 5, 2003), which is based on French Patent Application No. 01/15388, filed Nov. 28, 2001.

### FIELD OF THE INVENTION

This invention pertains to accessing multimedia and video electronic mail, programs and multimedia or video sequences by authorized users and provides a method and system for transmitting the video electronic mail or the programs and/or interactive multimedia sequences to display screens such as television sets, the transmission being managed and controlled by a single-line or multiple-line telephone, a mobile telephone or a cell phone.

### BACKGROUND

The demand for interactive multimedia services is steadily increasing. The multimedia information distribution systems based on communication networks, e.g., video-on-demand systems, are rapidly expanding and are characterized by their complexity. However, in many cases these distribution systems are very costly to implement at the user end, lack security and flexibility in use and adaptability to different clients and their requirements.

WO 00/11871 discloses a system and method enabling the user to order and download media files selected from distributed sites of content providers via a telecommunication network. The system comprises a multiplicity of user sites, each comprising a localized reception and display or reading subsystem in an enclosure having a simple user interface, a multiplicity of content-provider sites and a transaction server. The reception and display or reading subsystem allows the user to connect to the transaction server via a telecommunication network to access the list of available media files. The user can then select the desired files and request the transaction server to download the selected files via the receiver/display and communication network. The file request, the encryption of the file and the transfer instructions are transmitted from the transaction server to the content-provider site where the requested files are stored. The encoded files are encrypted in a dynamic manner by the content-provider site and downloaded in a secure manner to the requesting reader/receiver. The reader/receiver automates and manages the decryption and decoding of the downloaded files and the display or reading of these files via a conventional domestic television set and/or an audio system. This prior art obliges the user to be located solely at a fixed address. Moreover, users cannot receive multimedia data outside of their domicile.

U.S. Pat. No. 5,790,174 discloses a public switched telephone network (PSTN) supplying video signals from a video-information provider to one or more subscribers of a multiplicity of subscribers. A subscriber uses either a standard telephone via the PSTN or a dedicated control device via an ISDN (Integrated Services Digital Network) by packets for ordering the video program. The request is transmitted to a designated video-content provider and a digital transmission link is established between the video-information provider and the central office serving the subscriber. The connectivity between the central office and the subscriber is provided by an ADSL (Asymmetrical Digital Subscriber Line) via local loop interface units. The interface units perform a frequency multiplexing between the digital video information and the voice information for the subscriber and support the transmission of the subscriber's reverse control channel to the central office to transmit in the ISDN packet network in the direction of the video-information provider. The interfaces also enable a signalization in base band and audio between the central office and the subscriber for a conventional telephonic connectivity.

U.S. Pat. No. 5,712,906 discloses a PSTN for providing information from a multimedia information server to at least one subscriber of a multiplicity of subscribers, comprising a central office for receiving multimedia information signals from a multimedia information server and commanded by the subscriber. The central office comprises a portal system for transmitting the routing data in response to the subscriber's command and a switch for routing the multimedia signals from the server to the subscriber as a function of the routing data. An interface present in the central office transmits and receives the telephonic audio service signals, the subscriber control signals and the multimedia digital information signals in the first, second and third signal channels. Each of the subscriber premises comprises an interface for transmitting and receiving the telephonic audio service signals, the subscriber control signals and the digital multimedia information signals in the three signal channels. A multiplicity of local subscriber loops interconnects each subscriber interface with the interface of the central office. The multimedia information is collected from the information providers and stored in media servers that provide libraries of control sessions and data. The software modules in the media servers and the resident terminals enable establishment of an interactive multimedia session, the exchange of databases and the joint preparation of multimedia presentations.

U.S. Pat. No. 5,802,283 discloses a PSTN for providing information from a multimedia information server to any subscriber from among a multiplicity of subscribers comprising a central office for receiving multimedia information signals from a multimedia information server and commanded by the subscriber. U.S. '283 is part of the previously cited patent family (U.S. Pat. No. 5,712,906). U.S. '906 is distinguished from U.S. '283 by its device which has the characteristic of being able to transfer and redirect the multimedia information between two user, e.g., in the context of a video conference, with the users only being able to receive the information at their domicile.

### SUMMARY OF THE INVENTION

This invention relates to a method for accessing video electronic mail and/or video programs, and/or video sequences received by and/or stored in multimedia servers by a wide area network by authorized users equipped with devices in a distribution system for accessing video and multimedia electronic mail from a single-line telephone or a mobile or cellular voice telephone for display under selected conditions on television screens, including accessing an applicable multimedia server via the wide area telecommunication network with a telephone; verifying the identity and authorization of the user by the server; preloading a transfer protocol and/or a decoding or unscrambling software program from the server to a video interface device connected to the wide area telecommunication network; ordering transfer of one or more video or multimedia electronic mails, video or multimedia data or program(s) or sequence(s) to the video interface device for substantially immediate display or for at least a partial storage and/or delayed display; verifying the identity of the user and of rights of the user in relation to possible restrictions of use; and displaying, transferring, recording or processing the video electronic mail(s) and/or program(s) and/or sequence(s) transferred on the instructions of the user.

This invention also relates to a distribution system for accessing video or multimedia electronic mail from a simple single-line telephone or a mobile telephone or voice cellular telephone for displaying under selected conditions on television screens including one or more multimedia servers receiving and storing at least one video electronic mail, video programs and sequences and each linked to a wide area telecommunication network; and a multiplicity of video interface devices also connected to the wide area telecommunication network and installed in the users' domiciles or in predetermined sites different from the users' domiciles, each video interface device being associated with a least one television screen type display device and a cellular telephone or a simple single-line telephone, the telephone and the display device being independent of the user's domicile and of the user, and the telephone including a connection to the server, a connection between the server or by video interface device to a display device for receiving, exchanging and transferring information with the server and a connection for participating in the transfer and exchange of multimedia data, the server including a system for preloading an appropriate transfer protocol and/or a decoding or unscrambling software program from the server to the video interface device and a system for verifying the identity of the user and rights in relation to restrictions on use prior to the execution of the step of display, transfer or processing of the electronic mail.

### BRIEF DESCRIPTION OF THE DRAWINGS

Better understanding of the present invention will be obtained from the description below presenting the physical basis of the present invention and with reference to the attached drawing representing a preferred mode of implementation of this invention as a nonlimitative example of implementation.

In the attached drawing:

FIG. 1 is a basic diagram of a distribution system according to aspects of the invention, and

FIG. 2 represents a preferred example of implementation of the system according to aspects of the invention.

### DETAILED DESCRIPTION

This invention provides a flexible and personalizable system and device responsive to the mobility of the users. Another advantage of this invention is that the server makes the decision to redirect the data as a function of the location of the itinerant client upon a request or without a request. The server can also decide to distribute multimedia information to a group of users, but in distinction to the prior art according to which two users can exchange media information by establishing a direct connection, in this invention two users can exchange multimedia data without establishing a direct connection with each other, but by redirecting the multimedia information, e.g., on the television type display device at the domicile of a first user and from the fixed line telephone of the domicile of a second user. The invention is described below in connection with non-limiting examples of implementation.

A principal problem resolved by this invention is providing access to different video or multimedia data with a simple telephone, i.e., a telephone lacking in multimedia capacity and possibilities. With the solution of the invention, it is possible to receive a multimedia message or electronic mail on a portable telephone solely if the telephone is capable of displaying multimedia and/or video type information. In the contrary case, i.e., if the cell phone has no possibility of displaying video or multimedia information, the consultation-display of this type of message is not possible.

This invention improves upon the prior art in which the telephonic instrument is used solely to establish a connection with the server, for identifying the user and for the user to order multimedia data. In this invention, the telephone is used not only for connecting to the server, but also for being connected by the server or by an interface device box with the display equipment for receiving, exchanging and transferring information with the server and participates in the transfer and exchange of multimedia data. Moreover, irrespective of whether the telephone is a fixed line telephone or a cell phone, it is independent of the user's domicile and of the user, as is the display device, e.g., such as a television set, independent of the user and the user's domicile.

This invention improves upon the prior art in which the user can be located solely at a fixed address and cannot receive multimedia data anywhere other than his domicile. According to this invention, the user can receive the multimedia data independently of the site where the user is located. In the prior art, the communication of the order is implemented solely in the unilateral direction of client->server and the transfer of video information is implemented solely in the unilateral direction of server->client. In the invention the communication is bilateral, e.g., the server can decide to transmit the information to a user or to a set of users without these users having issued an order. The server can also decide to transfer the multimedia information to another server as a function of the location of the client and the type of display device present on the premises and to inform the user of the availability of the information.

According to this invention, it is possible to receive with any mobile or cellular telephone a message or electronic mail comprising multimedia or video type data, even if this telephone has no capability of displaying fixed or moving images, the goal then being to display these images on a screen such as, e.g., the screen of a television set.

Another aspect of the invention is to be able to request from a simple conventional single-line or multiple-line, analogue or digital telephone the reading, visualization and display of a multimedia message which was received on the user's cell phone without it being necessary to connect the cell phone to the cellular network.

According to the invention, the previously mentioned objective is achieved by providing a video interface device to connect at least one display device, e.g., a display device such as a television set, to at least one video and multimedia source, characterized in that it is composed of a module comprising principally, on the one hand, a digital processing unit adapted for processing, in particular decoding and unscrambling, any type of video stream using a preloaded decoding and unscrambling software program to display it in real or delayed time, store it, record it and/or transmit it on a telecommunication network and, on the other hand, at least one screen interface, at least one storage or recording interface, a connection interface to a local or wide area network, a user communication and control interface, the interfaces being linked and driven by the processing unit and preferably installed in or on the module.

Turning now to the Drawings, in its broadest sense, the invention provides a method for accessing video electronic mail and/or video programs, and/or video sequences received by and/or stored in suitable multimedia servers (5) by means of a wide area network (3) by authorized users equipped with devices in a distribution system for accessing video and multimedia electronic mail from a simple single-line telephone or a mobile or cellular voice telephone for display under given conditions on television set screens, comprising:

using a telephone (2, 10) for accessing the applicable multimedia server (5) via the wide area telecommunication network (3);

verifying the identity and the authorization of the user by the applicable server (5);

ordering the transfer of one or more video or multimedia electronic mails, video or multimedia data or program(s) or sequence(s) to an identified video interface device (8) also connected to the wide area telecommunication network (3) for immediate display or for at least a partial storage and/or delayed display;

displaying, transferring, recording or processing in another manner the video electronic mail(s) and/or program(s) and/or (sequence(s) transferred on the instructions of the user,

characterized in that it comprises:

a step of preloading a suitable transfer protocol and/or a decoding or unscrambling program from said server (5) to said video interface device (8); and

a step of verification of the identity of the user and the user's rights in relation to possible restrictions of use prior to the execution of the step of displaying, transferring or processing the electronic mail.

The method preferably furthermore comprises:

displaying, transferring, recording or processing in another manner the video electronic mail or the program(s) or sequence(s) transferred upon the decision of the server and after the server had verified the identity and the rights of the user in relation to possible restrictions of use.

The method advantageously furthermore comprises:

displaying, transferring, recording or processing in another manner the video electronic mail or the program(s) or sequence(s) transferred upon call after decision of the video interface device (8) to the user and/or the server, as a function of the instructions of the user and authorization of the server, after verification of the identity and the rights of the user in relation to possible restrictions of use.

According to another embodiment, the method comprises the uses of a fixed line telephone or of a cellular telephone linked logically to the user's domicile for displaying the multimedia content on a display device at the user's domicile.

According to yet another embodiment, the method comprises the use of a fixed line telephone or of a cellular telephone linked logically to the user for displaying the multimedia content on a display device at a predetermined site different from the user's domicile.

According to a preferred mode of implementation, the method comprises the use of a fixed line telephone not linked logically to the user's domicile or of a cellular telephone not belonging to the user for displaying the multimedia content on a display device at the user's domicile.

According to another preferred mode of implementation, the method comprises the use of a fixed line telephone not belonging to the user's domicile or of a cellular telephone not belonging to the user for displaying the multimedia content on a display device at a predetermined site different from the user's domicile.

The servers can preferably decide on the transmission, transfer, diffusion or distribution of a multimedia content to a group of users.

The interface devices (8) can advantageously decide to transmit, transfer, diffuse or distribute the multimedia content to a group of users.

According to one embodiment, the links between the servers (5), the interface devices (8) and the users are bilateral and the exchange of multimedia data is performed in both directions.

According to another embodiment, the method provides a multimedia interactivity among the users without said users having a direct connection between each other.

A group of users can advantageously decide on the transmission, transfer, diffusion or distribution of a media content from a server after said server has verified the identity and the rights of the users in relation to possible restrictions of use.

According to a preferred mode of implementation, the multimedia server (5) decides that the module (8) stores the video electronic mail or the multiple content on the hard disk or any other storage device of the module (8).

According to another preferred mode of implementation, the module (8) itself decides to store the video electronic mail or the multimedia content on its hard disk or its storage device.

The invention also pertains to a distribution system for accessing a video or multimedia electronic mail from a simple single-line telephone or a mobile telephone or voice cellular telephone for displaying under the given conditions on television screens for the implementation of the previously described method, comprising, on the one hand, one or more multimedia servers (5) receiving and storing at least one video electronic mail, video programs and sequences and each linked to the wide area telecommunication network (3) and, on the other hand, a multiplicity of video interface devices (8) also connected to the wide area telecommunication network (3) and installed in the users' domiciles or in predetermined sites different from the users' domiciles, each video interface device (8) being associated with a least one television screen type display device (7) and a cellular telephone (2) or a simple single-line telephone (10), the telephone and the display device being independent of the user's domicile and of the user himself, and the telephone comprising means for connecting to the server, means for being connected by the server or by the video interface device to the display device for receiving, exchanging and transferring information with the server and means for participating in the transfer and exchange of multimedia data, the server comprising means for preloading an appropriate transfer protocol and/or a decoding or unscrambling program from the server (5) to said video interface device (8) and means for verification of the identity of the user and his rights in relation to restrictions on use prior to the execution of said step of display, transfer or processing of the electronic mail.

The system preferably analyzes and transforms the content of the multimedia data as a function of the characteristics of the display device.

The system advantageously analyzes and transforms the content of the multimedia data as a function of the flow rate of the telecommunication network.

According to one embodiment, the system analyzes and transforms the content and flow rate of the multimedia data as a function of the price that the user is willing to pay, the user having the possibility of negotiating different transfer parameters such as the flow rate, the error level and the transfer speed.

According to another embodiment, the system enables connection and cohabitation of different technologies possibly endowed with multimedia capacities.

According to a preferred mode of implementation, the screen interface comprises a standard screen interface via cable and/or a wireless screen interface.

According to yet another embodiment, the network connection interface is connected to a wide area telecommunication network directly or via a local network serving as access network and is constituted of a digital subscriber line interface such as a modem, a satellite or cable interface, an optical fiber line interface or a radio frequency interface for radio communication.

According to a particular mode of implementation, the module, preferably comprising all of the interfaces, constitutes an independent device installed in a suitable protective enclosure.

The module and preferably all of the interfaces are advantageously installed inside a television set, on the electronic control card of the television set or at least partially on a separate card.

The invention also pertains to a distribution system for transferring video programs and multimedia sequences on a wide area telecommunication network to authorized users or subscriber systems for displaying under the given conditions on appropriate screens, comprising, on the one hand, one or more multimedia servers receiving and storing at least programs and video sequences and each connected directly or via a portal or a portal server and/or an access network to a wide area network and, on the other hand, a multiplicity of the above video interface devices also connected to a wide area network and installed in the users' domiciles or in predetermined locations, each interface device being associated with at least one television screen type display device.

The invention also pertains to a distribution system for transferring video programs and multimedia sequences on a wide area telecommunication network to authorized users or subscriber system for displaying under the given conditions on appropriate screens, comprising a multiplicity of video interface devices integrating a display device as a receiver of the personal digital assistant type with integrated screen connected to a wired or wireless telecommunication network.

The portal server can store a part or the totality of the multimedia content in a manner to be able to transmit to any module without having to submit a request to the multimedia server. The portal server can make the decision to distribute to a user or a group of users personalized multimedia data or the same audiovisual message with or without request on the part of the users. The server can also decide to redirect the information to one or other media servers as a function of the itinerant location of a user or a group of users.

In an example of implementation, the server transmits multimedia data to a LAN (Local Area Network) type server such as, e.g., an enterprise network or a domestic network from which the clients can consult the multimedia data or redirect them to other users.

The module can also store all or part of the multimedia content on its hard disk or any other storage device such as, e.g., flash memory, in a manner such that it is not necessary to interrupt the incoming data stream when the user wants to pause or request again a prior content by reversing. The portal server can decide whether the module should store the multimedia content on the hard disk or the storage device of the interface module 8.

The module 8 itself can decide to store the multimedia content on its hard disk or on its storage device.

The video interface device 8 is adapted for connecting at least one display device, e.g., a television screen type device 1, to at least one telecommunication network interface 6. This device comprises a module 8 comprising principally, on the one hand, a processing unit suitable for processing, in particular decoding and unscrambling, video streams according to a preloaded decoding and unscrambling software program in real or delayed time, of storing, recording and/or transmitting on a telecommunication network and, on the other hand, of a screen interface 7 and a local or wide area network connection 6.

The hard disk or the storage device of the module 1 can be used as buffer memory for momentarily storing at least a part of the program or video sequence to be displayed, in the case of delayed visualization or limitations in the passing band of the transmission network. Visualization can be delayed or deferred upon the request of the user or the portal server.

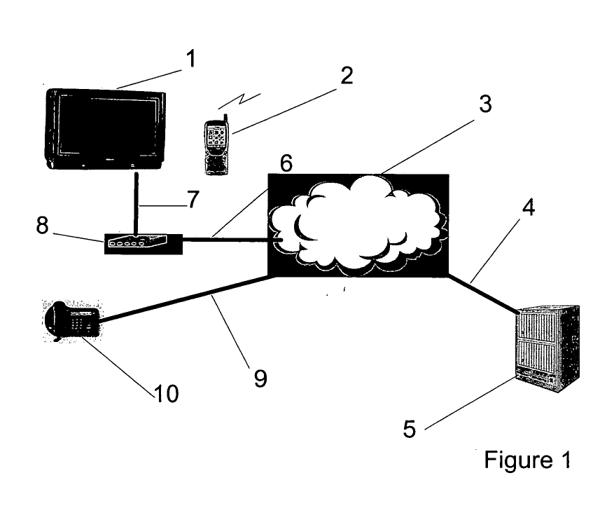

As shown in FIG. 1, the network connection interface 6 is connected to a wide area network 3 directly or by a local network serving as an access network and is constituted, e.g., of a digital subscriber line (DSL), such as a modem, a satellite modem, a cabled modem, an optical fiber line interface or a radio or infrared interface for wireless communication.

The module 8 is also capable of displaying, in superimposition on the image/decoded images, graphical information for guiding the user. It is also capable of making the decision to call the module 10 or the module 2 or the server 4 to consult, download, redirect, store and distribute information, e.g., messages, whether they be corporate or personal messages, for each client or for a group of clients.

The protective enclosure or the television set can also moreover integrate the interfaces (the structures and the transmission protocols of these interfaces being known by the expert in the field), a part of the peripheral equipment connected to these interfaces, of the PDA (personal digital assistant) type or any other receiver capable of receiving radio waves in a manner to receive the data and display them directly on its integrated screen or indirectly on the screen of a television set.

The invention also pertains to a physical device used by the consumer for accessing the data. This physical device is located in the user's domicile or in a predetermined location. It provides a set of functionalities that manage the appropriate information to be presented according to the selection of the audience and manages the connection and communication with the remote server, which is itself capable of transmitting radio waves to any other receiver, e.g., of the PDA type.

The invention also pertains to a distribution system for transferring coded video programs and multimedia sequences on a wide area network 3 to authorized users or subscriber systems for display under given conditions on suitable screens 1, comprising, on the one hand, one or more multimedia servers 5 receiving and storing at least video and multimedia programs and sequences and connected directly or via a portal or a portal server and/or an access network to a wide area telecommunication network 3 and, on the other hand, a multiplicity of video interface devices 8 as previously described also connected to a wide area network 3 and installed in the users' domiciles or in predetermined locations accessible to the users, each video interface device 8 being associated with at least one display device of the television screen type 1.

The multimedia servers 5 comprise means for coding, transcoding and scrambling video data, in particular, means for adding cryptographic or security information at the beginning and along the entire length of the sequences.

Although the invention is most particularly focused on video data such as video electronic mail, it is understood that all interactive multimedia information and all interactive data can be processed by the device and the system, video data being the most intricate/complicated.

The server 5 provides standard telephone, web and internet capacities to provide access to all types of multimedia information. It also verifies, manages and implements the subscription of all users who want to be connected to any multimedia server whether or not it is part of the system, to be able to redirect the multimedia information to the site where the user is located at that moment.

To consult electronic mail or multimedia message from a simple cellular telephone, the user calls a messaging service in a conventional manner then, at the moment of displaying the message, the user informs the messaging service that the user wants to view the video and multimedia part on a television set. The location of the television set in question could have already previously been specified to the messaging system, the site and thus the address of the television set being associated with the cellular telephone number or with multiple cell phone numbers and/or their voice and multimedia boxes.

Another possibility of the invention allows the user to command the consultation of the user's multimedia message from the user's cell phone by informing the messaging system of a temporary address for designating the television set on which the user wants to view the user's message at that precise instant.

Another possible realization of the invention allows the user to command consultation of the multimedia message from any cell phone or fixed line telephone from outside the user's domicile by informing the messaging system of a temporary address for designating the television set on which the user wishes to view a message at that precise instant. Another possibility of the invention allows the user to command the display on a television set by consulting the user's multimedia voice box from a simple telephone. This option has the advantage of allowing consultation of the message even in the absence of a cellular network or even in the absence of a cellular telephone either because the cellular network is overloaded or because the cellular reception-transmission conditions are not of good quality. In this case, from a simple telephone handset, the user can punch in the consultation number of the user's voice box, identify the user by punching in a voice box number, then indicate from the user's telephone keypad that the user wants to consult the multimedia message on the television set associated with the voice box or that the user wants to display the message on another television set whose logical address the user will specify via the telephone keypad of the conventional telephone set with which the user has established this telephonic connection with the voice messaging system.

Another possible realization of the invention allows the user to command the consultation of a multimedia message from any cell phone or fixed line telephone outside of the user's domicile by informing the messaging system of a temporary address for designating the television set to which the user wants the server to transmit the multimedia data, the television set being at the domicile of a second user, and after verification of the rights of the two users by the server, to display the multimedia data on the television screen of the second user.

The user must call the user's messaging server to gain access to the video and multimedia server 5. The user takes a telephone handset 2, 10 to do this and, after having picked up the receiver, punches in an access telephone number to the user's messaging system which is located in the wide area telecommunication network 3, this telephone being a single-line or multiple-line telephone 10 or a mobile or cellular telephone 2 not having a multimedia display.

The messaging system 5 automatically identifies the caller's number if it is available via the telecommunication network 3. In the contrary case, the messaging system 5 asks the user for an identification by punching in the user's messaging number on a telephone keypad 10 or 2.

The identification can be made either by providing the user's telephone number, the correspondence between the number of the voice and multimedia box then being made automatically by the messaging system 5, or by direct identity between the number composed on the keypad 10 or 2 by the user and the number of the voice and multimedia box 5 located in the telecommunication network 3.

The subscriber user can be located anywhere in the world and use any telephone handset whatsoever to connect to a server 5 of the system. By using an appropriate security procedure, such as automatically transmitting the identification number of the user's telephone, the user is recognized by the server 5 as being the valid subscriber and the user can extract all video electronic mail or any multimedia program from any multimedia server 5 to be downloaded on the user's module 8 (the module of the site where the user is located).

The video electronic mail or multimedia program is then transmitted onto the user's module 8 and automatically displayed on a television screen 1, if the user is facing the television screen or is close to it. Otherwise, the multimedia program is stored on the hard disk of the module 8.

Upon request from the user, the video electronic mail or multimedia program can be retransmitted to any other television screen or device connected to the module 8 if the user requires that the multimedia program be retransmitted.

Another possibility is that the server decides to transmit the information to the user, e.g., personalized multimedia electronic messages or a multimedia audiovisual message intended for a group of users. In this case, the electronic mail is transmitted directly onto the module(s) 8 to be displayed immediately, or is downloaded onto module(s) of the site where the user(s) can are located to be displayed on a delayed basis.

Another possibility is that the server decides to transmit the information to the user, e.g., multimedia electronic messages. In this case, each electronic mail is downloaded on the module 8 of the site where the user is located then the module 8 decides to inform the user.

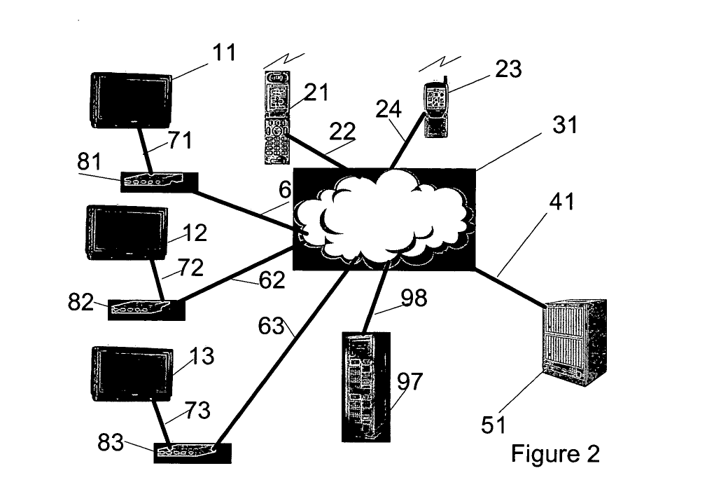

A preferred example of implementation of the system of the invention is presented in FIG. 2.

A client 21 is connected by means of a portable telephone via the network link 22 to the portal and multimedia server 5 which contains a table with the list of the clients (21, 23, 97) and an identifier for each client. The portal and multimedia server 5 also contains a table with the list of display devices for each client (physical address, e.g., of the interface devices 81, 82, 83, connected to the network by the links respectively 61, 62, 63) with a priority display device or by default. Upon the request of the client 21, the portal server 5 can remove or add a display device address or telephone number in its list. As a function of the client's profile and habits, the server can rank the identifier of the display device 81, 82 or 83 in the table of addresses in a priority position as a function of the flow rate of the transmission line 61, 62 and 63 or the user's multimedia mail storage parameters. The user 21 punches in the address of the server 5 on the telephone keypad to connect to the portal server. Another option is voice recognition identification via the telephone to implement the connection to the server.

The server 5 contains a directory composed of three parts: a table containing the list of the identifiers of the users, a table with the list of the identifiers of the display terminals 81, 82 and 83, relative to the screens 11, 12 and 13 (for example, the number of the interface devices (Set Top Box or STB)) and a table with the list of the permanent or temporary telephone numbers corresponding to each client.

The tables containing the list of display terminals and the users' telephone numbers are shared by multiple clients thereby ensuring the transparent interoperability between the display terminals and the users. The portal server 5 can replicate the same display device for multiple clients upon the request of these clients or by decision of the server as a function of the availability of the terminals, the geographic localization of the clients, the flow rate requested by each client or the urgency of multimedia mail transfer requested. The information contained in the tables can be parameterized by the server 5 or upon the request of the client 21, 23 or 97. The calling telephone can also be shared by multiple clients. In this case, the portal server identifies the telephone number as well as the personal identifier of each client.

When a user 21 is connected to the portal and multimedia server 5, and after identification of the telephone and the user, the user sends to the server a request to consult the user's multimedia mail, designating the address of the display device 81, 82 or 83 on which the user wants to display the multimedia mail. The portal server identifies the display device, makes a connection with it and addresses its multimedia databases to recover the information which is transferred temporarily onto the hard disk or recording equipment of the interface device (STB), e.g., 81. The client displays the data and decides whether or not to save the data on the hard disk or the storage device of the STB 81. According to another variant, the portal server or the STB can decide on the temporary or permanent storage on the STB's storage device of the multimedia data as a function of the analysis of their content, as a function of the date or as a function of the available space. According to another embodiment, the server 5 can decide as a function of the client's rights, profile and habits to send the data in advance to the hard disk of the STB having the client's priority address, and then to send a message on the client's priority telephone to inform the client of the data transfer. The client can also be contacted by the STB informing the client of the receipt of multimedia data from the server or any sender.

When the user 21 wants to send multimedia content and after connection to the server, identification and loading of the appropriate protocol for data transfer, the STB sends to the server two separate streams: one containing the identification of the addressee, a priority telephone number and the number of a default display device, for example. The second stream contains the multimedia data of video, audio or text type. The server recovers the two streams and directs the content to the addressee 23, e.g., via the connection 24. The server can also decide to send the content to a terminal other than the one requested by the sender or contact the address on another telephone number as a function of the addressee's profile and temporary characteristics stored in the data table of the server relative to each client. The server also decides to temporarily store the transmitted content or to send it to the hard disk of the addressee's STB or to construct a message for the addressee as a function of the multimedia information content. The server also decides at the moment of the transfer of the contents without the user's request as a function of the capacities of the telecommunication network, the quantity of information, their content and/or the client addressee's profile.

The portal and multimedia server 5 and the STB 8 also contain multimedia content analysis and transformation tools. For example, they can modify the format of the content as a function of the available flow rate on the telecommunication network and the price that the user is willing to pay for the recovery or transmission of the data. The server and the STB can also modify the format of the multimedia data as a function of the size, type and standard of the display screen 11, 12 or 13 and send them to these screens via the links 71, 72, or 73, e.g., reducing the size of the image from a DVD format for display on an automobile screen or a portable television. The server and the STB also transform the messages as a function of the type of telephone providing the users with connections, thereby ensuring cohabitation of multiple telephonic standards.

The server and the STB thus adapt the multimedia contents to compatible formats and ensure the interoperability and cohabitation of different multimedia and telephonic standards. The device of the invention is evolutive as a function of the different telecommunication means, auto-decisional and auto-adaptive as a function of the content of the multimedia information, the capacities of the network, the display devices and telephones, and the client's profile (habits, payments, temporary location). The architecture of the system enables the personalization of the services, interoperability of different technologies and direct or indirect interactivity among multiple users.

The server 5 and the STB 8 can decide on the automatic transfer of multimedia messages to a group of users as a function of their characteristics.

The device is evolutive by its decisional capacities to contact clients, transfer, analyze and modify the contents to adapt them to the transfer conditions, the client's location and/or profile.

An example of application is the transfer of multimedia data via a telecommunication network 3. The user 21 calls the portal server 5 with a telephone of type UMTS (Universal Mobile Telecommunication System) with video display capability to transmit an audiovisual information unit to the user 23 who is equipped with a simple telephone of type GSM (Global System for Mobile) and connected to the network via the radio link 24. The portal and multimedia server 5 possesses an interface for the identification of the different types of telephonic devices, content analysis and transformation, and adaptation of the format of the contents. It thus can ensure the compatibility and cohabitation of telephonic standards such as UMTS, GSM, GPRS (General Packet Radio Service), portable telephones equipped with I-mode, and conventional fixed line and wireless telephones. The server identifies that the addressee 23 of the video message has a telephone of type GSM without multimedia display capability. The server then sends a GSM-compatible message, e.g., an SMS (Short Message Service), to inform the addressee that a multimedia message has been received. The server can also send a voice message indicating the presence of multimedia audiovisual mail or send to the user the voice part of the multimedia message. The addressee 23 connects to the portal server and after identification the server asks on which of the terminals (11, 12 or 13) does the addressee want to display audiovisual content. The client designates, for example, the number of the STB with its display screen 13 on which the client wants to receive the video content. The server verifies whether the display device is available and not occupied by another user and as a function of the network capacities and the type of display screen decides to transform, adapt and transfer the content via the link 63 to the STB 83. The server can also send the unmodified video content into the STB. At that moment, the STB 83, by means of its analysis and modification tools, can decide to transform the data received as a function of the type of screen or their content.

Another example of application is the case in which the user 97 is equipped with a computer and decides to send via the link 98 the same audiovisual message to the user 21 equipped with a UMTS telephone and the user 23 equipped with a GSM telephone.

The server then determines that the addressee of the video message has a telephone of the type GSM without capability of multimedia display. The server therefore sends a GSM-compatible message, e.g., a SMS (Short Message Service), to inform the addressee of receipt of a multimedia message. The server can also send a voice message indicating the presence of audiovisual mail or send the user the voice part of the audiovisual message. The addressee 23 connects to the portal server and after identification designates the number of the STB on which the addressee wants to receive the video content, e.g., the device 82 with its television screen 72. The server verifies whether the display device is available and as a function of the network capacities and the type of display screen decides to transform and adapt the content and transfer it. The server can also send the unmodified video content into the STB. At this moment, the STB by means of its analysis and modification tools can decide to transform the data received as a function of the type of screen or their content.

The user with a portable UMTS 21 telephone receives via the portal server an information unit informing the user of receipt of multimedia content in the user's messaging system and that the audiovisual multimedia content was sent by user 97. The information unit can be in text or voice form, and/or contain all or part of the video data or audio that has been received in the messaging system. As a function of the content of the message, the user decides to display the message on a television screen or on the screen of a portable telephone, this telephone possessing the capability of multimedia display. The user connects to the server and after personal identification and identification of the telephone, a UMTS transfer is established with the corresponding communication protocols between the network of the server and the UMTS telephone.

The communication protocols establish the rules to be respected to implement the data transfer. The communication protocols used are present in the radio part of the UMTS called UMTS Radio Access Network (UTRAN) and are based on the low layers of the OSI/ISO model. Their functionalities are distributed between the user equipment 21 and the Fixed Radio Network linked 3 to the portal and multimedia server. The complex communication process is organized by layers. The server makes the request to the receiver and tells it that the service is confirmed when the link between the two is established by means of the message protocol exchange between the two parts which contain multiple steps. The server requests the connection and when the request indication reaches the telephone, the telephone responds and the confirmation is sent to the server. After identification of the telephone number and the display device, the server prepares the data by packaging them with multiple successive headers to form the packaged IDU (Interface Data Unit) block which is transported to the terminal and unpackaged by the terminal. At the level of the physical layer, the transport services are of two types: in connected mode (circuit mode) and in unconnected mode (packet mode). The selection of the transport mode is made by the server and the terminal. For example, the terminal decides to establish a transport service in connected mode because this mode allows the UMTS terminal (thus the user) to negotiate the transfer conditions of the multimedia data in terms of flow, maximum authorized error rate and maxim transfer delay. If the negotiation is successful, the connection is established and remains valid until a release request arrives from the server or the terminal. The data are transferred to the terminal during this step. The UMTS transport protocols make it possible to change the conditions under which the data are transferred during the route and notably this is particularly suitable for transport of multimedia information in which the requirements in terms of data type and transfer flow rate can vary to very great extents. Once the transfer is terminated the transfer is closed by the UMTS service called “RELEASE”. If during the transfer the telephone analysis device detects too many errors, e.g., more than the maximum authorized error rate, it can immediately interrupt the transfer using the UMTS service called “ABORT”. The network can also interrupt the transfer at any time with the UMTS functionality called “P-ABORT”, if for example it determines that the assessed quality of the channel is insufficient for the transfer of the multimedia data.

If the server decides to transfer the data in packet mode, the radio channel resources are allocated as a function of the quantity of data, the radio resources available and the price that the user is willing to pay. This mode is very suitable for the transport of very large quantities of information.

The data are transferred by the physical layer divided into transport channels and controlled by the protocols of the top layers of the UTRAN architecture. The transport channels can be of two types: dedicated (for the circuit or packet mode) and common (for the exchange of information between the network and the terminals). Each channel is adapted for sending specific data. For example, to send video data to the UMTS terminal, the DCH channel (Dedicated Channel) is used in dedicated mode solely by one user for transferring the information in connected mode or it can also be used in dedicated mode shared by a packet mode transfer by multiple users equipped with UMTS terminals.

1. A method for accessing video electronic mail and/or video programs, and/or video sequences received by and/or stored in multimedia servers by a wide area network by authorized users equipped with devices in a distribution system for accessing video and multimedia electronic mail from a single-line telephone or a mobile or cellular voice telephone for display under selected conditions on television screens, comprising:
accessing an applicable multimedia server via the wide area telecommunication network with a telephone;
verifying the identity and authorization of the user by the server;
preloading a transfer protocol and/or a decoding or unscrambling software program from the server to a video interface device connected to the wide area telecommunication network;
ordering transfer of one or more video or multimedia electronic mails, video or multimedia data or program(s) or sequence(s) to the video interface device for substantially immediate display or for at least a partial storage and/or delayed display;
verifying the identity of the user and of rights of the user in relation to possible restrictions of use; and
displaying, transferring, recording or processing the video electronic mail(s) and/or program(s) and/or sequence(s) transferred on the instructions of the user.

2. The method according to claim 1, further comprising displaying, transferring, recording or processing in another manner the video electronic mail or the program(s) or sequence(s) transferred upon the decision of the server and after the server had verified the identity and the rights of the user in relation to possible restrictions of use.

3. The method according to claim 1, comprising displaying, transferring, recording or processing in another manner the video electronic mail or the program(s) or sequence(s) transferred upon call after decision of the video interface device to the user and/or the server, as a function of instructions of the user and authorization of the server, after verification of the identity and the rights of the user in relation to possible restrictions of use.

4. The method according to claim 1, comprising displaying the multimedia content on a display device at the user's domicile with a fixed line telephone or a cellular telephone linked logically to the user's domicile.

5. The method according to claim 1, comprising displaying multimedia content on a display device at a predetermined site different from the user's domicile with a fixed line telephone or of a cellular telephone linked logically to the user.

6. The method according to claim 1, comprising displaying multimedia content on a display device at the user's domicile with a fixed line telephone not linked logically to the user's domicile or of a cellular telephone not belonging to the user.

7. The method according to claim 1, comprising displaying multimedia content on a display device at a predetermined site different from the user's domicle with a fixed line telephone not belonging to the user's domicile or of a cellular telephone not belonging to the user.

8. The method according to claim 1, wherein the servers can decide on transmission, transfer, diffusion or distribution of multimedia content to a group of users.

9. The method according to claim 1, wherein the interface devices can decide to transmit, transfer, diffuse or distribute multimedia content to a group of users.

10. The method according to claim 1, wherein links between the servers, the interface devices and the users are bilateral and exchange of multimedia data is performed in both directions.

11. The method according to claim 1, providing a multimedia interactivity among the users without the users having a direct connection between each other.

12. The method according to claim 1, wherein a group of users can decide on transmission, transfer, diffusion or distribution of media content from a server after the server has verified the identity and rights of users in relation to possible restrictions of use.

13. The method according to claim 1, wherein the multimedia server decides that the module stores the video electronic mail or the multiple content on the hard disk or any other storage device of the module.

14. The method according to claim 1, wherein the module decides to store the video electronic mail or the multimedia content on its hard disk or its storage device.

15. A distribution system for accessing video or multimedia electronic mail from a simple single-line telephone or a mobile telephone or voice cellular telephone for displaying under selected conditions on television screens, comprising:
one or more multimedia servers receiving and storing at least one video electronic mail, video programs and sequences and each linked to a wide area telecommunication network; and
a multiplicity of video interface devices also connected to the wide area telecommunication network and installed in the users' domiciles or in predetermined sites different from the users' domiciles, each video interface device being associated with a least one television screen type display device and a cellular telephone or a simple single-line telephone, the telephone and the display device being independent of the user's domicile and of the user, and the telephone comprising a connection to the server, a connection between the server or by video interface device to a display device for receiving, exchanging and transferring information with the server and a connection for participating in the transfer and exchange of multimedia data,
the server comprising a system for preloading an appropriate transfer protocol and/or a decoding or unscrambling software program from the server to the video interface device and a system for verifying the identity of the user and rights in relation to restrictions on use prior to the execution of the step of display, transfer or processing of the electronic mail.

16. The distribution system according to claim 15, that analyzes and transforms content of the multimedia data as a function of characteristics of the display device.

17. The distribution system according to claim 15, that analyzes and transforms content of the multimedia data as a function of the flow rate of the telecommunication network.

18. The distribution system according to claim 15, that analyzes and transforms content and flow rate of the multimedia data as a function of price that the user is willing to pay, the user having the possibility of negotiating different transfer parameters such as the flow rate, the error level and the transfer speed.

19. The distribution system according to claim 15, enabling connecting and cohabiting of different technologies optionally having multimedia capacities.
